(19) United States
(12) Patent Application Publication
(10) Pub. No.: US 2008/0096483 A1
(43) Pub. Date: Apr. 24, 2008

(54) POWER SAVING CIRCUITS FOR TIME DIVISION MULTIPLE ACCESS AMPLIFIERS

(75) Inventors: V. Alan Van Buren, Cedar City, UT (US); Volodymyr Skrypnyk, Hurricane, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Wilson Electronics, St. George, UT (US)

(21) Appl. No.: 11/551,563

(22) Filed: Oct. 20, 2006

(51) Int. Cl. H04B 1/04; H04B 7/15; H01Q 11/12

(52) U.S. Cl. 455/11.1; 455/127.1

(57) ABSTRACT

A method and system for conserving power consumption within a network amplifier. The system includes a first communication device for receiving a Time Division Multiple Access (TDMA) signal. The TDMA signal includes both broadcasting timeslots and non-broadcasting timeslots. A power amplifier amplifies the TDMA signal to generate an amplified TDMA signal. The TDMA signal is analyzed by a sensing circuit for detecting the presence of the broadcasting timeslots. The sensing circuit turns the power amplifier on during the broadcasting timeslots and off during the non-broadcasting timeslots so that the power amplifier only amplifies the TDMA signal during the broadcasting timeslots and does not amplify the TDMA signal during the non-broadcasting timeslots. The resultant amplified TDMA signal is then transmitted by a second communication device.

### BACKGROUND

1. The Field of the Invention

The present invention relates generally to cellular network amplifiers. More specifically, embodiments of the present invention relate to systems and methods for conserving power within a cellular network amplifier for amplifying TDMA signals.

2. The Relevant Technology

In recent years, cellular (“cell” or “mobile”) telephones have dramatically increased in popularity. A growing number of people are relying exclusively on cell phones, and are abandoning their traditional land line telephone services in favor of the convenience of the mobility of cell phones. This increase in cell phone reliance has resulted in the need for reliable cellular signal coverage over a wider area.

Use of cell phones in areas having a weak signal often results in dropped calls which can be annoying for the cell phone user and expensive for the wireless service provider. Dropped calls typically result when the signal between the cell phone and the base station is lost. A loss of signal may occur for a number of reasons, including interference due to buildings or mountains, or an increase in distance between the cell phone and the base station. Therefore, a particular need exists to increase the reliability of cell phones near large buildings and in vehicles driving long distances in remote areas.

Attempts have been made to increase the reliability of cell phones through use of cell phone signal boosters, also known as cellular network amplifiers. Cellular network amplifiers receive the cellular signal sent from a base station, amplify the signal, and retransmit the signal to one or more cell phones. Similarly, the cellular network amplifier receives the signals from one or more cell phones, amplifies the signals, and retransmits the signals to the base station.

Cellular network amplifiers are typically placed in relatively close proximity to one or more cell phones, and serve the purpose of increasing the level of the signals being transmitted to and from the cell phones so that the cell phones can communicate with base stations that would otherwise be out of range. Some amplifiers are configured to be integrated with the cell phone itself or with a cell phone cradle. Alternatively, other amplifiers are configured to be placed in a separate location from the cell phone itself. For example, a cellular network amplifier may be placed in a user's vehicle, or in or near a building that otherwise may have poor reception.

One shortcoming common to many cellular network amplifiers is their tendency to consume large amounts of power. Many network amplifiers set the quiescent current of the amplifier to a high level in order to achieve linearity and minimize distortion and spurious energy that may interfere with the amplifier and with other users of the RF spectrum. The high level of quiescent current results in relatively high current and power consumption. Conserving power is particularly relevant to network amplifiers that are battery operated, but can also be problematic for all types of network amplifiers due to the increase in heat dissipation and overall size of the network amplifier that often accompany high power levels.

Techniques for dealing with high levels of power consumption have included, for example, increasing the thermal conductivity or mass of the amplifiers case, adding heat conducting fins, adding a fan, and the like. These techniques increase the weight and cost of the amplifier and may make the amplifier more cumbersome for the user.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment is directed to a network amplifier designed for conserving power consumption. The system includes a first communication device for receiving a Time Division Multiple Access (TDMA) signal. The TDMA signal includes both broadcasting timeslots and non-broadcasting timeslots. A power amplifier amplifies the TDMA signal to generate an amplified TDMA signal. The TDMA signal is analyzed by a sensing circuit for detecting the presence of the broadcasting timeslots. The sensing circuit turns the power to the power amplifier on during the broadcasting timeslots and off during the non-broadcasting timeslots so that the power amplifier only amplifies the TDMA signal during the broadcasting timeslots and does not amplify the TDMA signal during the non-broadcasting timeslots. The amplified TDMA signal is transmitted by a second communication device to a target destination.

A further embodiment is directed to a method of conserving power within a network amplifier. The method includes receiving a TDMA signal, including both broadcasting timeslots and non-broadcasting timeslots. The presence of the broadcasting timeslots within the TDMA signal are then detected. The method further includes controlling a power amplifier so that the power amplifier only amplifies the TDMA signal during the broadcasting timeslots and does not amplify the TDMA signal during the non-broadcasting timeslots. Finally, the output signal produced by the power amplifier is transmitted to a target destination.

Another embodiment described in more detail herein includes a sensing circuit for controlling a power amplifier in a network amplifier. The system includes a Monolithic Microwave Integrated Circuit (MMIC) amplifier for amplifying a TDMA signal, where the TDMA signal includes both broadcasting timeslots and non-broadcasting timeslots. A rectifier circuit receives the amplified TDMA signal and converts the amplified signal to a direct current voltage. A comparator circuit is employed for determining the presence of the broadcasting timeslots and for turning a power amplifier on when the broadcasting timeslots are present and turning the power amplifier off when the non-broadcasting timeslots are present.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a block diagram of a cellular communications system;

FIG. 2 illustrates a schematic of one embodiment of a power saving network amplifier;

FIG. 3 illustrates a schematic of one embodiment of a bidirectional power saving network amplifier;

FIG. 4 illustrates a schematic of one embodiment of a sensing circuit used for analyzing a TDMA signal and controlling a power amplifier; and

FIG. 5 is a flow diagram of an exemplary method for conserving power within a network amplifier.

### DETAILED DESCRIPTION

In the following detailed description of the preferred embodiments, reference is made to the accompanying drawings which form a part hereof, and in which are shown by way of illustration specific embodiments of the invention. It is to be understood that other embodiments may be utilized and structural changes may be made without departing from the scope of the present invention.

Embodiments of the invention relate to a network amplifier that is designed to conserve power. Some of the signals used in communication networks, including RF networks such as cellular telephone networks, rely on various schemes to maximize the use of bandwidth. Embodiments of the invention selectively amplify a given signal according to some criteria. The following invention is described in terms of TDMA, but one of skill in the art can appreciate, with the benefit of the present disclosure, the applicability of the invention into other multiple access schemes.

Embodiments of the present invention relate to a network amplifier that is designed to receive a TDMA signal and conserve power while the TDMA signal is not broadcasting information. A TDMA signal transmitted to or from a handset is typically made up of a broadcasting timeslot sequentially followed by one or more non-broadcasting timeslots that can be used by other handsets operating in the same channel for transmitting information. The network amplifier includes a sensing circuit for analyzing the TDMA signal to determine whether a broadcasting timeslot or a non-broadcasting timeslot is being transmitted to or from the handset. When a broadcasting timeslot is detected, the sensing circuit instructs a power amplifier to amplify the TDMA signal. Conversely, when a non-broadcasting timeslots is detected, the sensing circuit instructs the power amplifier to power down so as to conserve power while amplification is not needed.

For purposes of the present invention, the following definitions are provided. The terms “cellular” and “cellular network” refer to a wireless telephone network that connects radio transmissions between a mobile phone and a system of multiple cell sites, each including an antenna and a base station, to a mobile telephone switching office, and ultimately to the public wireline telephone system. Cellular calls are transferred from base station to base station as a user travels from cell to cell. One of skill in the art can appreciate that embodiments of the invention can be applied to other wireless networks as well.

By way of example, the phrase “cell phone” refers to a wireless device that sends and receives messages using radiofrequency signals in the 800-900 megahertz (MHz) portion of the radiofrequency (RF) spectrum, and the phrase “PCS phone” (personal communication system phone) refers to a wireless device that uses radiofrequency signals in the 1850-1990 MHz portion of the RF spectrum. For purposes of simplicity, as used herein, the terms “cell phone” and “handset” are intended to cover both “cell phone” and “PCS phone”, as defined above, as well as other handheld devices. Likewise, as used herein, the phrase “cellular signal” refers to signals being transmitted both in the cell phone spectrum (i.e., 800-900 MHz) and in the PCS spectrum (i.e., 1850-1990 MHz). One of skill in the art can appreciate that embodiments of the invention are not limited to operation in these spectrums, but can be applied in other portions of the frequency spectrum as well.

“Cell site” and “base station” are used herein interchangeably. Cell site and base station are defined as the location where the wireless antenna and network communications equipment is placed. A cell site or base station typically includes a transmitter/receiver, antenna tower, transmission radios and radio controllers for maintaining communications with mobile handsets within a given range.

The word “uplink” refers to the transmission path of a signal being transmitted from a handset to a base station. The word “downlink” refers to the transmission path of a signal being transmitted from the base station to the handset. The phrases “uplink signal” and “downlink signal” are not limited to any particular type of data that may be transmitted between a handset and a base station, but instead are simply used to specify the direction in which a signal is being transmitted.

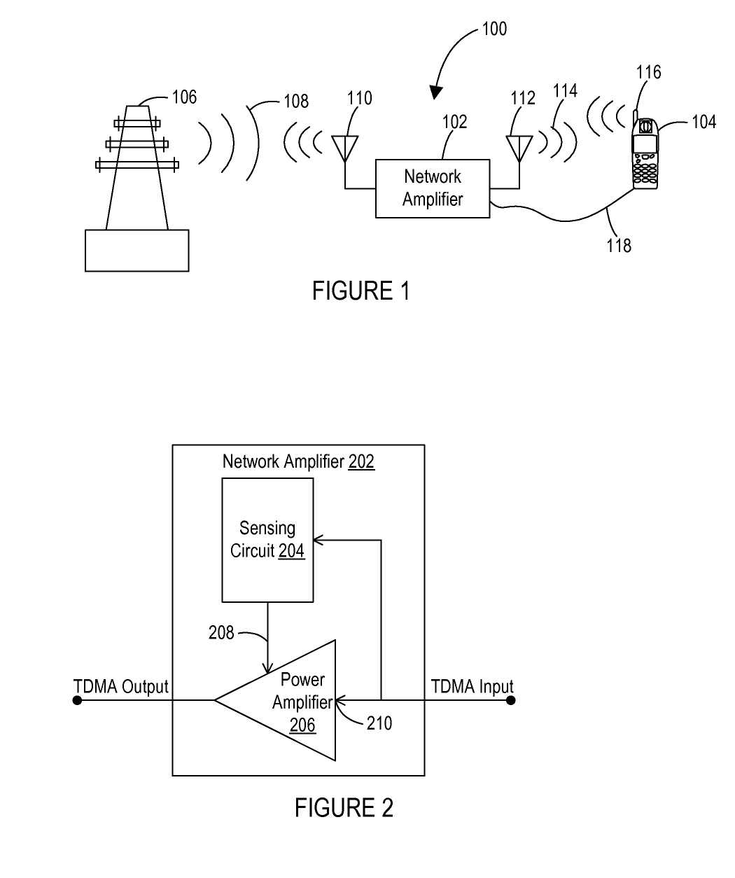

Referring now to FIG. 1, an exemplary communications system 100 is illustrated. The communications system 100 may be a cellular telephone wireless network or other wireless network. In this example, a network amplifier 102 amplifies the signals transmitted between a base station 106 and a handset 104. In a typical system, the network amplifier 102 is located in close proximity to the handset 104 in comparison to the distance to the base station 106. The base station 106 transmits a signal 108 into the surrounding air, which is attenuated for various reasons known to one of skill in the art as it travels outward from the base station 106. An antenna 110 receives the signal 108 and converts the signal into an electrical equivalent.

The network amplifier 102 amplifies the electrical signal and communicates the amplified signal to the handset 104 in one of two ways. First, the amplifier 102 may retransmit the electrical signal from a second antenna 112 as an amplified RF signal 114, which is received by an antenna 116 of the handset 104. Second, the amplifier 102 may communicate the electrical signal to the handset 104 via a wired connection 118. The handset 104 ultimately processes the signal and communicates the appropriate content to a user of handset 104.

Similarly, the handset 104 may communicate content to the network amplifier 102 by transmitting a signal from the antenna 116 or the wired connection 118. The network amplifier 102 amplifies the received signal and retransmits the signal using the antenna 110. The transmitted signal is received by the base station 106, which may perform a number of operations on the signal, as determined by the wireless service provider.

Many cellular networks utilize digital transmission techniques, such as time division multiple access (TDMA), for increasing the number of channels that can be provided by a cellular network. As will be appreciated by one of ordinary skill in the art, a TDMA channel allows several handset users to share the same frequency by allocating their signals different timeslots. The users transmit in rapid succession, one after the other, each using their own timeslot. In other words, a TDMA signal transmitted to and from a handset can be divided into broadcasting timeslots, when the handset is receiving or sending information, and non-broadcasting timeslots, when the handset is not receiving or sending information. Other handsets may use the non-broadcasting timeslots of a particular handset as their broadcasting timeslots.

TDMA is used in many different communication protocols including, for example, Global System for Mobile communications (GSM), Integrated Digital Enhanced Network (iDEN), Personal Digital Cellular (PDC), Digital AMPS (D-AMPS), and the like. The ratio of broadcasting timeslots to non-broadcasting timeslots varies for the different TDMA protocols. For example, an iDEN signal typically has one broadcasting timeslot followed by two non-broadcasting timeslots, while a GSM signal typically has one broadcasting timeslot followed by seven non-broadcasting timeslots.

Conventionally, a network amplifier often consumes unnecessary power during the non-broadcasting timeslots. The power amplifiers located within a network amplifier often require a relatively high quiescent current in order to maintain linearity of the amplifier. The quiescent current is typically present within a conventional network amplifier both during broadcasting and non-broadcasting timeslots, thereby consuming a substantial amount of power even when there is no need for the network amplifier to amplify an incoming signal (i.e., during the non-broadcasting timeslots).

Referring now to FIG. 2, a more detailed depiction is provided of a network amplifier 202, which is one embodiment of the network amplifier 102, configured for conserving power consumption. The network amplifier 202 includes a sensing circuit 204 and a power amplifier 206. The network amplifier 202 may also include various other components that are commonly used in network amplifier configurations. The network amplifier 202 is designed to conserve power by controlling the power amplifier 206 such that the power amplifier only amplifies a TDMA signal during the broadcasting timeslots. During non-broadcasting timeslots, the power amplifier 206 is turned off, thereby minimizing the power consumed by the power amplifier during the non-broadcasting timeslots.

When a TDMA input signal is received by the network amplifier, the sensing circuit 204 analyzes the TDMA signal to determine whether the signal contains a broadcasting timeslot or a non-broadcasting timeslot. When the sensing circuit 204 detects a broadcasting timeslot, the sensing circuit 204 immediately sends a control signal 208 to the power amplifier 206 instructing the amplifier to turn on. When the power amplifier 206 is turned on, the amplifier amplifies the signal received at the input 210. Conversely, when the sensing circuit 204 detects a non-broadcasting timeslot, the sensing circuit 204 immediately sends a control signal 208 to the power amplifier 206 instructing the amplifier to turn off When the power amplifier 206 is turned off, the amplifier will not amplify the signal received at the input 210 and the amplifier will be placed in a state where power consumption is minimized. For example, when the power amplifier 206 is turned off, any quiescent current supplied to the amplifier is minimized or eliminated. The sensing circuit 204 and the power amplifier 206 are configured such that the power amplifier can be turned on and off in rapid succession and with minimal delay so that any adverse affect to the quality of the amplified TDMA signal is minimized or eliminated.

In one embodiment, the TDMA input signal received by the sensing circuit 204 is an uplink signal received from a handset. The TDMA input signal is analyzed and amplified, as described above, and is then transmitted via an antenna to a base station, as illustrated in FIG. 1. The connection between the handset and the network amplifier 202 may be a wired connection. Alternatively, an antenna may be employed for establishing a wireless link between the handset and the network amplifier 202 so that the user of the handset is not physically connected to the network amplifier. Regardless of whether the TDMA input signal is received via a wired connection or a wireless connection, the sensing circuit 204 is able to control the power amplifier 206 without requiring a separate control signal from the handset providing data regarding whether a broadcasting timeslot or a non-broadcasting timeslot is being transmitted.

In another embodiment, the TDMA input signal is a downlink signal received from a base station. The TDMA input signal is analyzed and amplified, as described above, and is then transmitted via either an antenna or a wired connection to a handset, as illustrated in FIG. 1.

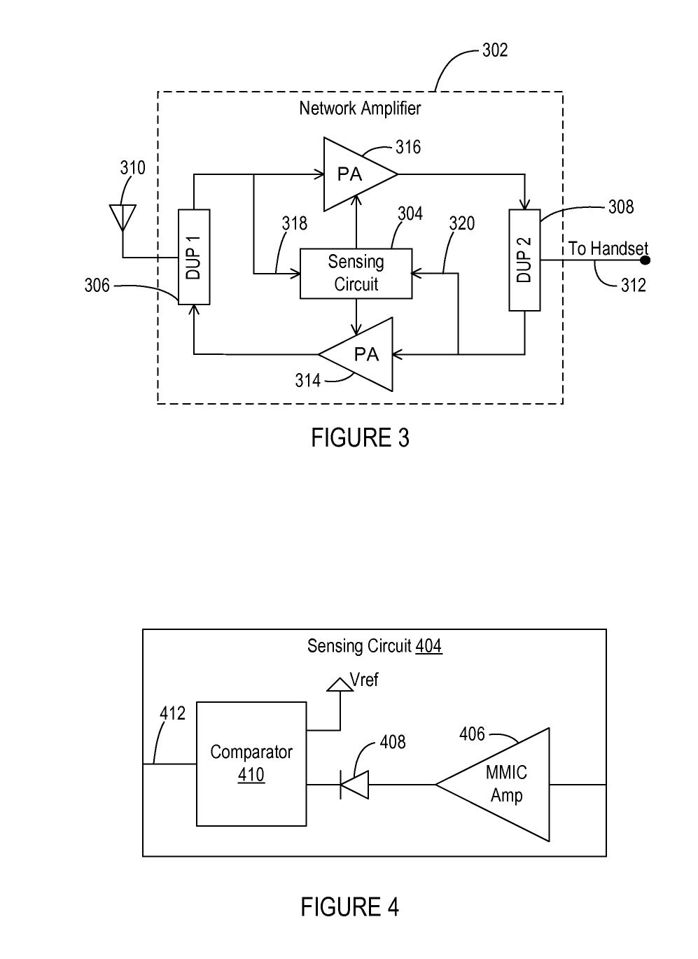

FIG. 3 illustrates one embodiment of a bidirectional network amplifier 302. The bidirectional network amplifier 302 has a sensing circuit 304 that is configured to control multiple power amplifiers 314 and 316. Similar to the communications system 100 illustrated in FIG. 1, a TDMA signal is received from a base station at the antenna 310 and is passed to both the sensing circuit 304 and the power amplifier 316. The sensing circuit 304 determines whether the TDMA signal received from the base station presently includes a broadcasting timeslot or a non-broadcasting timeslot. The sensing circuit 304 turns the power amplifier 316 on during the broadcasting timeslots and turns the power amplifier 316 off during the non-broadcasting timeslots. The amplified TDMA signal from the base station is then communicated to the handset via either a wired or wireless connection.

The bidirectional cellular amplifier 302 is also configured to receive a TDMA signal from one or more handsets, amplify those signals, and retransmit the signals to a base station. The signals from the handsets may be received via either a wired or wireless connection. The signals are routed to a second power amplifier 314, which is also controlled by the sensing circuit 304. The sensing circuit 304 turns the power amplifier 314 on or off depending on whether the TDMA signal received from the handset presently includes a broadcasting or a non-broadcasting timeslot.

In order to allow the antenna 310 and the connection 312 between the handset and the network amplifier 302 to simultaneously transmit and receive TDMA signals, duplexers (DUP) 306 and 308 are provided, by way of example. A duplexer is an automatic electrical device that permits the use of the same antenna for concurrently transmitting and receiving. More generally, a duplexer is a three port device with one common port “A” and two independent ports “B” and “C”. Ideally, signals are passed from A to B and from C to A, but not between B and C. For example, the duplexer 308 receives an RF signal from a base station via the antenna 310 and routes the signal to the inputs of the power amplifier 316 and the sensing circuit 304. The duplexer 308 simultaneously receives a second electrical signal from the output of the power amplifier 314, and causes this signal to be transmitted as an RF signal via the antenna 310.

Although the network amplifier 302 is illustrated as having only a single sensing circuit 304, the network amplifier 302 may have multiple sensing circuits for each of the inputs it receives. For example, two sensing circuits may be provided, a first for analyzing the TDMA signal received from the handset and for controlling the power amplifier 314, and a second for analyzing the TDMA signal received from the base station and for controlling the power amplifier 316. Furthermore, if the broadcasting timeslots and the non-broadcasting timeslots of the TDMA signals received from the handset and from the base station are being transmitted simultaneously, the sensing circuit 304 may control both power amplifiers 314 and 316 by only analyzing one of the input signals 318 or 320.

FIG. 4 illustrates an exemplary embodiment of the sensing circuit 404 which may be employed for analyzing TDMA signals received from a handset or a base station and for controlling a power amplifier. The sensing circuit 404 may include one or more Monolithic Microwave Integrated Circuit (MMIC) amplifiers 406 for amplifying the received TDMA signal to a required level. The resultant signal is fed to a diode detector circuit 408 for converting an AC input into a DC output. The comparator 410 compares the output of the diode detector 408 to a predetermined reference voltage (‘Vref’). If the output of the diode detector 408 exceeds that of the Vref voltage level, the output 412 of the comparator 410 instructs a power amplifier to turn on. Conversely, if the output of the diode detector 408 does not exceed that the Vref voltage level, the output 412 of the comparator 410 instructs the power amplifier to turn off

The components of the sensing circuit 404 are designed such that the AC signal present during a broadcasting timeslot of a TDMA signal results in a DC voltage at the output of the diode detector 408 that exceeds the Vref voltage level. Therefore, the presence of a broadcasting timeslot causes the output 412 of the comparator 410 to instruct the power amplifier to turn on, and the presence of a non-broadcasting timeslots causes the output of the comparator 410 to instruct the power amplifier to turn off

As described previously, the link between the network amplifier 202 or 302 and the incoming TDMA signal may be wired or wireless. Where a wireless link is employed, the sensing circuit 404 may include additional functionality for handling the issues that are presented when receiving a wireless signal. For example, the sensing circuit 304 may include a filtering circuit for reducing noise levels within the received TDMA signal. If the filtering circuit creates a significant delay, the power amplifier 314, 316 may further include a delay circuit for delaying the TDMA signal in order to compensate for the delay in the sensing circuit 304 thus resulting in synchronization between the sensing circuit and the signals passing through the power amplifier, 314,316.

The sensing circuit 404 illustrated in FIG. 4 is merely one example of the sensing circuit that may be employed for controlling a power amplifier. Other configurations may also be employed, as will be appreciated by one of ordinary skill in the art.

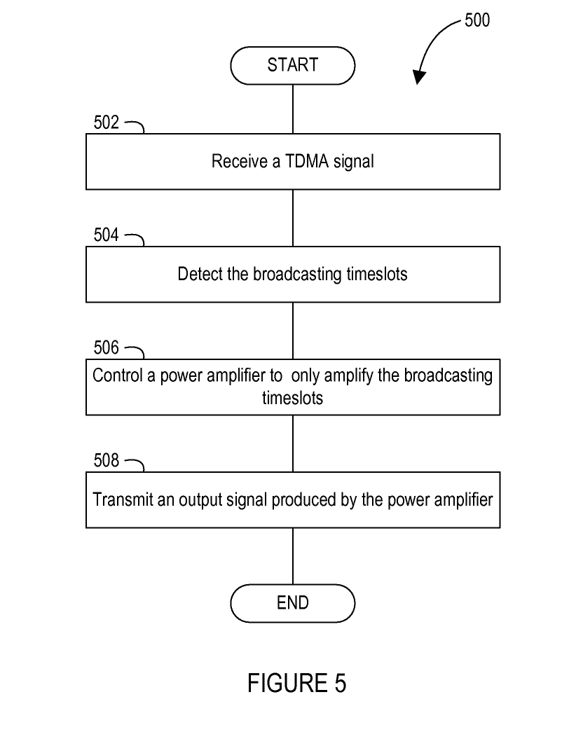

FIG. 5 illustrates one embodiment of a method 500 of conserving power within a network amplifier. The method 500 receives 502 a TDMA signal which includes both broadcasting timeslots and non-broadcasting timeslots. As described previously, a typical TDMA signal transmitted to or from a handset includes one broadcasting timeslot followed by one or more non-broadcasting timeslots in succession. In one embodiment, the TDMA signal is received from a handset, either via a wired connection or via an antenna. In another embodiment, the TDMA signal is received from a base station via an antenna.

The method 500 then detects 504 the presence of the broadcasting timeslots within the TDMA signal. Referring once again to FIGS. 2-4, a sensing circuit 204, 304, or 404 may be employed for detecting whether a broadcasting timeslot or a non-broadcasting timeslot exists.

A power amplifier is controlled 506 so that the power amplifier only amplifies the TDMA signal during the broadcasting timeslots and does not amplify the TDMA signal during the non-broadcasting timeslots. Therefore, power is conserved during the non-broadcasting timeslots. The TDMA signal produced by the power amplifier is then transmitted 508 from the network amplifier, either to a base station or to a handset.

The present invention may be embodied in other specific forms without departing from its spirit or essential characteristics. For example, the present invention is not limited to cellular telephones but can be applied in any situation where TDMA signals are being amplified, regardless of context. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A network amplifier, comprising:
a first communication device for receiving a first Time Division Multiple Access (TDMA) signal, the first TDMA signal including broadcasting timeslots and non-broadcasting timeslots;
a power amplifier for amplifying the first TDMA signal to generate an amplified first TDMA signal;
a sensing circuit for detecting the broadcasting timeslots of the first TDMA signal and for turning the power amplifier on during the broadcasting timeslots and off during the non-broadcasting timeslots so that the power amplifier only amplifies the first TDMA signal during the broadcasting timeslots and does not amplify the first TDMA signal during the non-broadcasting timeslots; and
a second communication device for transmitting the first TDMA signal as amplified by the power amplifier.

2. The network amplifier as recited in claim 1, wherein the first communication device receives the first TDMA signal from a handset, and the second communication device transmits the amplified first TDMA signal to a base station via an antenna.

3. The network amplifier as recited in claim 2, wherein the first communication device is a wired connection or an antenna.

4. The network amplifier as recited in claim 1, wherein the first communication device receives the first TDMA signal from a base station via an antenna, and the second communication device transmits the amplified first TDMA signal to a handset.

5. The network amplifier as recited in claim 4, wherein the second communication device is a wired connection or an antenna.

6. The network amplifier as recited in claim 1, wherein the sensing circuit comprises:
a detector circuit for receiving the first TDMA signal and converting the first TDMA signal to a direct current voltage; and
a comparator circuit for determining the presence of the broadcasting timeslots and for turning the power amplifier on when the broadcasting timeslots are present and turning the power amplifier off when the non-broadcasting timeslots are present.

7. The network amplifier as recited in claim 6, wherein the sensing circuit further comprises a Monolithic Microwave Integrated Circuit (MMIC) amplifier.

8. The network amplifier as recited in claim 1, wherein the sensing circuit and the power amplifier are configured such that the power amplifier can be turned on and off with a minimal delay that does not significantly affect the quality of the amplified first TDMA signal.

9. The network amplifier as recited in claim 1, wherein the first TDMA signal is received via a wireless link, the sensing circuit further comprising:
a filter circuit for reducing noise levels within the first TDMA signal.

10. The network amplifier as recited in claim 9, further comprising:
a delay circuit for delaying the first TDMA signal being amplified by the power amplifier by a similar delay amount introduced by the filter circuit.

11. The network amplifier as recited in claim 1, wherein the communication device is further configured to receive a second TDMA signal, the network amplifier further comprising:
a second power amplifier for amplifying the second TDMA signal to generate a second amplified TDMA signal;
wherein the sensing circuit is further configured for detecting the broadcasting timeslots of the second TDMA signal and for turning the second power amplifier on during the broadcasting timeslots and off during the non-broadcasting timeslots so that the second power amplifier only amplifies the second TDMA signal during the broadcasting timeslots and does not amplify the second TDMA signal during the non-broadcasting timeslots; and
wherein the first communication device is further configured for transmitting the second TDMA signal as amplified by the second power amplifier.

12. The network amplifier as recited in claim 11, wherein the sensing circuit is comprised of separate circuits for detecting the broadcasting timeslots of the first and second TDMA signals.

13. A method for conserving power within a network amplifier, the method comprising:
receiving a Time Division Multiple Access (TDMA) signal, the TDMA signal including broadcasting timeslots and non-broadcasting timeslots;
detecting the presence of the broadcasting timeslots within the TDMA signal;
controlling a power amplifier so that the power amplifier only amplifies the TDMA signal during the broadcasting timeslots and does not amplify the TDMA signal during the non-broadcasting timeslots; and
transmitting an output signal produced by the power amplifier.

14. The method as recited in claim 13, wherein the TDMA signal is received from a handset.

15. The method as recited in claim 13, the TDMA signal being received via a wired connection.

16. The method as recited in claim 13, the TDMA signal being received via an antenna.

17. The method as recited in claim 13, wherein the TDMA signal is received from a base station via an antenna.

18. In a network amplifier, a sensing circuit for controlling a power amplifier, the sensing circuit comprising:
a Monolithic Microwave Integrated Circuit (MMIC) amplifier for amplifying a TDMA signal, the TDMA signal transmitted from a handset and including broadcasting timeslots and non-broadcasting timeslots;
a detector circuit for receiving the amplified TDMA signal and converting the amplified TDMA signal to a direct current voltage; and
a comparator circuit for determining the presence of the broadcasting timeslots and for turning a power amplifier on when the broadcasting timeslots are present and turning the power amplifier off when the non-broadcasting timeslots are present.

19. The sensing circuit as recited in claim 18, wherein the TDMA signal is received via a wireless link, the sensing circuit further comprising:
a filter circuit for reducing noise levels within the TDMA signal.

20. The sensing circuit as recited in claim 19, further comprising:
a delay circuit for delaying the TDMA signal being amplified by the power amplifier by a similar delay amount introduced by the filter circuit.
